(19) United States
(12) Patent Application Publication
(10) Pub. No.: US 2024/0346805 A1
(43) Pub. Date: Oct. 17, 2024

(54) OBJECT RECONSTRUCTION IN DIGITAL IMAGES

(71) Applicant: Hoffmann-La Roche Inc., Little Falls, NJ (US)

(72) Inventors: Szymon Grzegorz ADAMSKI, Gliwice (PL); Filippo ARCADU, Zurich (CH); Krzysztof KOTOWSKI, Gliwice (PL); Agata KRASON, Appenzell Outer Rhodes (CH); Bartosz Jakub MACHURA, Gliwice (PL); Jakub Robert NALEPA, Gliwice (PL); Jean TESSIER, Muespach (FR)

(73) Assignee: Hoffmann-La Roche Inc., Little Falls, NJ (US)

(21) Appl. No.: 18/443,690

(22) Filed: Feb. 16, 2024

Related U.S. Application Data
(63) Continuation of application No. PCT/EP2022/072887, filed on Aug. 17, 2022.

(30) Foreign Application Priority Data
Aug. 19, 2021 (EP) 21192182.0

(51) Int. Cl. G06V 10/774; G06T 7/00; G06V 10/26; G06V 10/82

(52) U.S. Cl. CPC G06V 10/774; G06T 7/0012; G06V 10/26; G06V 10/82; G06T 2207/10088; G06T 2207/20081; G06T 2207/20084; G06T 2207/30016; G06T 2207/30096; G06V 2201/03

(57) ABSTRACT

Methods disclosed herein relate generally to methods for training an algorithm and for using the trained algorithm for detection, segmentation and characterization of object instances in digital images, applicable for detection, segmentation and characterization of tumor burdens in images from brain MRI scans of Glioblastoma patients.

The present invention relates to object detection, segmentation and characterization in digital images. Various embodiments of the present invention relate to methods to train a model with a dataset of digital brain images and the use of the trained model for detection, segmentation and characterization of tumor burden in post-operative Glioblastoma (GBM) patients.

Magnetic Resonance Imaging (MRI) and Computed Tomography (CT) scans are the most commonly used tests in neurology, neurosurgery and neuro-oncology. MRI is based on the magnetization properties of atomic nuclei. MRI employs a uniform magnetic field to align the randomly-oriented protons in the body, then applies a Radio Frequency (RF) energy that excites the protons. After a certain period from the applied RF, the protons return to their resting magnetic alignment with different speeds and produce different signals, depending on the different types of tissues they constitute. MRI allows for visualization in three planes: axial, sagittal and coronal. CT technique is based on the different attenuation of X-rays in the different body tissues. Multiple CT images taken from different angles allow for cross-sectional images to be produced with reconstruction algorithms. Both MRI and CT scans require expert radiologists to read and interpret the acquired images.

In particular, evaluating the response to treatments for GBM patients depends on the accurate longitudinal radiological assessment of Magnetic Resonance (MR) images to estimate changes in tumor burden. The assessment is based on the bidimensional measurement of two perpendicular diameters of the contrast-Enhancing Tumor (ET) according to the Response Assessment in Neuro-Oncology (RANO) criteria, as well as the qualitative evaluation of abnormalities in the regions of edema (ED), with or without tumor infiltration. Radiological assessments are challenging, as the tumors are very heterogeneous in appearance, with an irregular shape associated with the infiltrative nature of the disease. The challenge is further aggravated in post-surgical scans by the presence of surgical cavity and brain distortion. As a consequence, radiological assessments are time consuming and subject to inter- and intra-reader variability. Volumetric analysis of the brain lesions has long been recognized as a possible method of uncertainty reduction on the simple bidimensional analysis. However, due to the extremely time-consuming manual segmentation of lesions, integrated volumetric assessment in GBM patients is only feasible with automated algorithms.

State-of-the-art Deep Learning (DL) models applied on pediatric brain tumors (Chang K. et al. “Automatic assessment of glioma burden: a deep learning algorithm for fully automated volumetric and bidimensional measurement.” Neuro-Oncol. 2019; 21(11):1412-1422. doi:10.1093/neuonc/noz106) have shown the success of fully-automated integrated volumetric and bidimensional diametrical measurements of ET. However, they present several limitations, including but not limited to: the scope of volumetric and diametrical measurements, limited to ET and not including ED and/or surgical cavity, both particularly relevant for post-operative GBM patients; the complexity of the optimization of the three separate algorithms employed; the oversimplified extraction of the RANO parameters; the lack of inter- and intra-reader variability dependence analysis; the use of small and non-heterogeneous multi-center clinical data. Thus there is a need for a method for training a model applicable for automated integrated volumetric and diametrical measurements that overcomes at least all the limitations of the current available models stated above. Further limitations and disadvantages of known models will become apparent to the skilled in the art, through comparison of the features of the prior art with some aspects of the present invention, as set forth in the remainder of the present invention and with reference to the drawings.

### BRIEF DESCRIPTION OF THE DRAWINGS

FIG. 1 depicts a scheme that illustrates an exemplary method for training a model with a dataset of digital brain images using at least one trained artificial neural network, in accordance with an embodiment of the invention.

FIG. 2 illustrates an exemplary instance of a system for object detection, segmentation and characterization in a digital brain image using at least one trained artificial neural network, in accordance with an example of the invention.

FIG. 3 depicts a block diagram that illustrates an exemplary data processing apparatus for object detection, segmentation and characterization using at least one trained artificial neural network, in accordance with an example of the invention.

FIG. 4 depicts a flow chart that illustrates an exemplary method for object detection, segmentation and characterization in a digital brain image using at least one trained artificial neural network, in accordance with an example of the invention.

FIG. 5 depicts a flow chart that illustrates an exemplary method for object detection, segmentation and characterization in a digital brain image using a single ensemble of five nnU-Nets, in accordance with an example of the invention.

### DETAILED DESCRIPTION

The present invention relates to object detection, segmentation and characterization in digital images. Various embodiments of the present invention relate to methods to train a model with a dataset of digital brain images and the use of the trained model for detection, segmentation and characterization of tumor burden in post-operative Glioblastoma (GBM) patients.

The following described implementations refer to aspects of the disclosed methods employed to train an artificial neural network and the use of an artificial neural network to detect and segment objects of interest in an image. When applied to digital images obtained from brain MRI scans, the training is performed on manually pre-annotated images. The trained model can be further designed to characterize the objects of interest, by extracting their features and through them assess the temporal evolution of the objects. When applied to brain MRI scans of post-operative GBM patients, the features extracted, such as but not limited to bidimensional diameters and volumes of the contrast-enhancing tumor (ET), of the regions of edema (ED) and of the surgical cavity, can show insights into the effect of the surgery performed, and/or assist in the clinical assessment of possible drug treatments and/or radiological treatments. When applied to brain MRI scans of pre-operative GBM patients, the features extracted, such as but not limited to bidimensional diameters and volumes of the contrast-enhancing tumor (ET), can assist in the clinical assessment of the necessity of surgery and/or drug treatments and/or radiological treatments.

Integrated volumetric and diametric measurements of tumor burden in GBM patients is only feasible with automated algorithms. In some examples, artificial neural networks are employed. An artificial neural network represents the structure of a human brain modeled on the computer. It consists of neurons and synapses organized into layers and can have millions of neurons connected into one system, which makes it extremely successful at analyzing and even memorizing various information. In some examples, Deep Learning models are employed. DL models are based on Deep Neural Networks (DNNs), which are networks comprising an input layer, one or more hidden layers and an output layer. DNNs have the ability to learn useful features from low-level raw data, and they outperform other Machine Learning (ML) approaches when trained on large datasets. Among the existing DNNs, Convolutional Neural Networks (CNNs) are particularly suited for image recognition tasks. CNNs are built such that the processing units in the early layers learn to activate in response to simple local features, for example patterns at particular orientations or edges, while units in the deeper layers combine the low-level features into more complex patterns. U-Nets are CNNs developed specifically for biomedical image segmentation. They are designed to yield with fewer training images more precise segmentations than normal convolutional neural networks. Based on the U-Nets design, no-new U-Nets (nnU-Nets) have been developed, which constitute a robust and self-adapting framework of simple U-Nets. In some examples, nnU-Nets are employed.

In some other examples, an end-to-end deep learning-powered pipeline is employed, to reduce the complexity arising from training several algorithms. In an example (“End-to-end deep learning pipeline for automated bidimensional and volumetric tumor burden measurement in pre- and post-operative GBM patients”, J. Nalepa, J. Tessier et al., to be published), the end-to-end deep learning-powered pipeline comprises a single ensemble of five nnU-Nets trained over different training sets to process images from both pre- and post-operative brain MRI scans. The nnU-Nets can be confidence-aware nnU-Nets, which are nnU-Nets trained on datasets comprising confidence estimates.

As used in the present invention, the term tumor burden refers to the number of cancer cells, the size of a tumor (ET), or the amount of cancer in the brain, as well as the size of any associated structure, such as the regions of edema (ED), with and without tumor infiltration, and the surgical cavity. With respect to this definition, the term lesion is a synonym of tumor burden.

The term sequence has the specific technical meaning of a magnetic resonance image collected with a particular setting of pulse sequences and pulsed field gradient, resulting in a particular image appearance defined by the gray levels in which different tissues appear. Co-registered sequences are sequences aligned to a common anatomical template.

In particular, several sequences are explicitly claimed in the present invention: native T1-weighted, post-contrast T1-weighted, T2-weighted and T2-Fluid Attenuated Inversion Recovery (FLAIR) MRI sequences. These differ in terms of the Repetition Time (TR) and Time to Echo (TE) with which the images are created: TR is the amount of time between successive pulse sequences applied to the same slice; TE is the time between the delivery of the Radio Frequency (RF) pulse and the receipt of the echo signal. T1-weighted sequences are produced by using short TE, preferably chosen to be approximately 14 milliseconds, and short TR, preferably chosen to be approximately 500 milliseconds. T2-weighted sequences are produced by longer TE, preferably chosen to be approximately 90 milliseconds, and longer TR, preferably chosen to be approximately 4000 milliseconds. T2-FLAIR sequences are produced with the longest TE, preferably chosen to be approximately 114 milliseconds, and the longest TR, preferably chosen to be approximately 9000 milliseconds. It is foreseeable that different values of TE and TR might be used by the person skilled in the art. Post-contrast T1-weighted sequences are T1-weighted sequences performed after infusing a contrast enhancement agent, like for example Gadolinium. Further details about the MRI sequences mentioned explicitly or not in the present invention are considered common knowledge of the person skilled in the art.

The word voxel regarding MRI sequences has the specific technical meaning of the 3D unit of the image. A typical voxel size for an MRI is 1 mm×1 mm×1 mm. It is foreseeable that different voxel sizes might be used by the person skilled in the art.

Further, it shall be noted that the terms classification, detection and segmentation in the present invention have the following specific technical meanings. Classification refers to establishing whether or not an object belongs to a certain class, like for example flowers, people, cars, crypts, or any other classes. Detection refers to locating the object position in an image, for example by predicting a bounding box around it. Segmentation refers to a classification performed at the pixel level, in contrast to the classification performed at the object level as defined above. Segmentation consists in classifying each pixel of an image according to whether or not a pixel belongs to a certain class of objects. Segmentation is typically carried out with the use of a mask, which can be a binary filter applied to an image to classify its pixels among those belonging to an object of interest, also referred to as signal, and those not belonging to an object of interest, also referred to as background.

According to some embodiments of the present invention, the term detection can comprise the object classification as well as the object detection as defined herein.

Moreover, the term epoch as used in connection with neural network models has the meaning of iteration, and the term batch defines the number of samples to work through before updating the internal model parameters. In the field of image processing, and as used in the present invention, a patch is a portion of the image that is processed individually. After the processing steps, the final image is reconstructed out of the individually processed patches. In some cases, the patches can be rescaled, also known as patch scaling, to increase the resolution. Other techniques can be employed in the field of image processing for data augmentation, for example image rotation, image mirroring, gamma correction as referred to in the present invention. Gamma correction consists of a power law transform used to correct the differences between the way a device captures content, the way a display displays content and the way the human visual system processes light. Gamma is the exponent of said power law, and assumes typical values between 0.45 and 2.2 in modern TV systems.

Finally, as used in the present invention, ranges are indicated in the form (x1, x2), wherein said range means any value larger than or equal to x1 and smaller than or equal to x2.

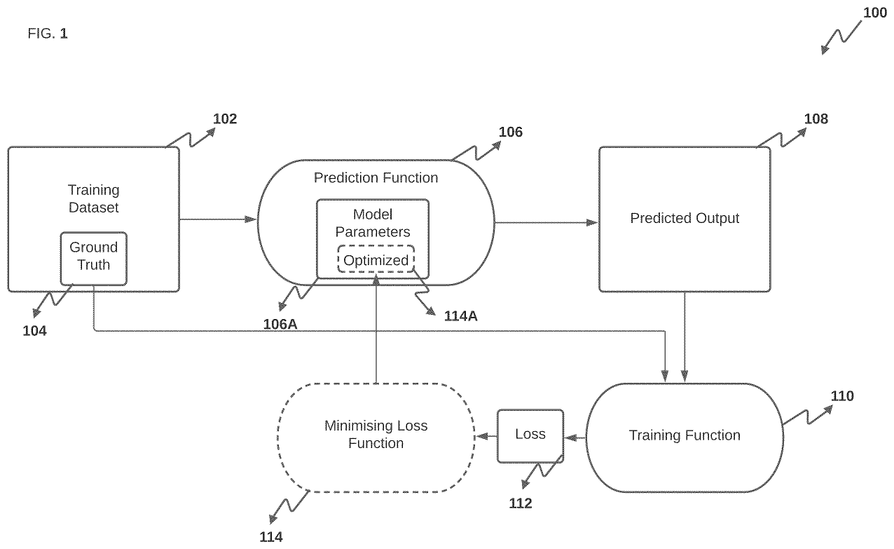

FIG. 1 depicts a scheme that illustrates an exemplary method for training a model with a dataset of digital brain images using at least one trained artificial neural network, in accordance with an embodiment of the invention. With reference to FIG. 1, an exemplary training method 100 is shown.

The training dataset 102 can comprise one or more images. Said images can be obtained from a combination of MRI brain scan sequences of pre- or post-surgical Glioblastoma (GBM) patients. MRI sequences can comprise, but be not limited to, native T1-weighted, post-contrast T1-weighted, T2-weighted and T2-Fluid Attenuated Inversion Recovery (FLAIR) MRI sequences. In some embodiments, for each patient the MRI acquisition can consist of: a) axial native T1-weighted sequences, b) 3D axial, coronal, and sagittal post-Gadolinium T1-weighted sequences, c) 2D axial T2-weighted sequences and d) 2D axial FLAIR sequences, with equal or less than 5 mm slide thickness, equal or less than 1.5 mm interslice gap, 0.1 mmol/kg of the Gadolinium contrast. In some embodiments, the MRI sequences can be co-registered. In some embodiments, each sequence can be normalized by the mean intensity divided by the standard deviation. In some embodiments, post-operative MRI sequences captured between 1 and 57 days after surgical intervention can be employed. Each image can contain one or more objects of interest. Objects of interest can comprise tumor lesions, including but not limited to contrast-enhancing tumor (ET), regions of edema (ED), and in the case of post-surgical sequences the surgical cavity. In some embodiments, the set of images from post-surgical MRI sequences used in the training process can be stratified in subsets, according to for example the distribution of partial and full resection, the number of days after surgery, the volumes of the tumor lesions. In such embodiments, the training of the model can be performed separately for each subset of the training dataset.

A ground-truth pixel-based annotation 104 can be received for each image of the training dataset 102. The pixel-based annotation 104 can include but be not limited to a ground-truth segmentation mask for every object of interest in the image. In an embodiment, the ground-truth segmentation mask in the annotation 104 can be performed manually by 7 readers, 2 of which labelled as experts with respectively 18 and 20 years of experience, and the others with experience between 2 and 6 years. The ground-segmentation mask in the annotation 104 can also be performed by a different number of readers, and/or readers with a different number of years of experience. Segmentation masks obtained by the non-experienced readers can be reviewed by one or more of the two or more experienced readers. In some embodiments, the annotation 104 comprises the reader's confidence level on the manual segmentation. In an embodiment, the confidence levels can range from 0.5, corresponding to “not confident at all”, to 1.5, corresponding to “fully confident”. Confidence levels can be set to 1 when no reader's level of confidence is reported in the ground-truth annotation 104.

A prediction function 106 can be used to extract for each object of interest in each image in the training dataset 102 a predicted segmentation mask 108. The prediction function can be defined by model parameters 106A. In an embodiment, the model parameters are randomly initialized. In some embodiments, the prediction function can include but not be limited to mathematical functions, artificial neural networks, deep neural networks, and other types of mappings. In another embodiment, the prediction function comprises a single ensemble of multiple artificial neural network base models. In a further embodiment, the multiple base models can be ensembled by averaging softmax probabilities.

A training function 108 can be used to calculate the loss 112 from the predicted segmentation mask 108 and the ground-truth segmentation mask in the annotation 104. In some embodiments, the training function can be a soft DICE loss function. In a further embodiment, the soft DICE loss function is defined per object of interest as

$${L}_{DICE} = 1 - 2 \vert P ∩ GT \vert / ( {\vert P \vert}^{2} + {\vert GT \vert}^{2} )$$

where P and GT indicate respectively the predicted segmentation mask 108 and the ground-truth segmentation mask in the annotation 104. In a further embodiment, the training function can be an averaged cross-entropy and soft DICE loss function. In a further embodiment, the training function can be the average of the single loss functions across all objects of interest, for example

$$L = \frac{[ L ( E T ) + L ( ED ) + L ( Cavity ) ]}{3}$$

In an embodiment, confidence-aware loss functions can be employed. Namely, the loss functions can be modified to include the reader's level of confidence in the segmentation, reported in the ground-truth annotation 104, denoted per object of interest as c(ET), c(ED), c(Cavity), for example

$${L}^{′} = \frac{[ {L}^{′} ( ET ) + {L}^{′} ( ED ) + {L}^{′} ( Cavity ) ]}{3}$$

where each L′=L×c.

A minimizing loss function 114 can be employed to minimize the loss with respect to the model parameters 106A. Model parameters which correspond to the minimum of the minimizing loss function can be selected as the optimized model parameters 114A and the randomly initialized model parameters 106A can be replaced by the optimized model parameters 114A. In an embodiment, the iterative method of stochastic gradient descent can be employed for optimizing the model. In a further embodiment, a stochastic gradient descent with Nesterov momentum (Nesterov, Y. (1983). A method for unconstrained convex minimization problem with the rate of convergence o(1/k2). Doklady ANSSSR (translated as Soviet.Math.Docl.), vol. 269, pp. 543-547) can be employed for optimizing the model. It will be obvious to the person skilled in the art that alternative optimization techniques can also be employed.

One or more further iterations of the training process can be performed, until the desired model accuracy can be reached. In an embodiment, the training can be performed for 1000 epochs. In another embodiment, the training can be performed for maximum 100 epochs, with an early stopping condition applied. The early stopping defines the effective number of epochs over which the training is performed. The effective number of epochs is decided by running the training over a validation set and based upon a given number of consecutive epochs after which the loss is not improved. In a further embodiment, several batches can be processed within one epoch, for example 250 batches per epoch, wherein each batch includes two patches of size 208×238×196. In a further embodiment, data augmentation can be realized by random patch scaling for example within the range (0.7, 1.4), and/or random rotation, and/or random gamma correction within the range (0.7, 1.5) and/or random mirroring.

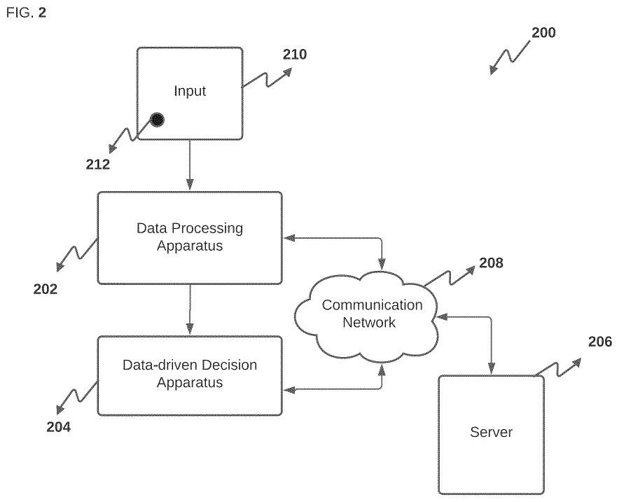

FIG. 2 illustrates an exemplary instance of a system for object detection, segmentation and characterization in a digital brain image using at least one trained artificial neural network, in accordance with an example of the invention. With reference to FIG. 2, the system 200 can include a data processing apparatus 202, a data-driven decision apparatus 204, a server 206 and a communication network 208. The data processing apparatus 202 can be communicatively coupled to the server 206 and the data-driven decision apparatus 204 via the communication network 208. In other examples, the data processing apparatus 202 and the data-driven decision apparatus 204 can be embedded in a single apparatus. The data processing apparatus 202 can receive as input an image 210 containing at least one object of interest 212. In other examples, the image 210 can be stored in the server 206 and sent from the server 206 to the data processing apparatus 202 via the communication network 208.

The data processing device 202 can be designed to receive the input image 210 and sequentially perform detection and segmentation of the at least one object of interest 212 in the input image 210 via at least one trained artificial neural network. In another example, the data processing device 202 can be configured to perform in parallel the detection and the segmentation of the at least one object of interest 212 in the input image 210 via a single trained artificial neural network. The data processing device 202 can allow for the extraction of features, including but not limited to, volumetric and bidimensional diametrical measurements of the objects of interest. Examples of the data processing device 202 include but are not limited to a computer workstation, a handheld computer, a mobile phone, a smart appliance.

The data-driven decision apparatus 204 can comprise software, hardware or various combinations of these. The data-driven decision apparatus 204 can be designed to receive as input objects and features outputted by the data processing device 202 and, for example in digital images from brain MRI scans, to assess the status of the disease based on said features of the detected and segmented tumor lesions. In an example, the data-driven decision apparatus 204 can be able to access from the server 206 the stored features of one object, extracted while processing different images comprising the object, whereby these different images can refer to sequences scanned at different points in time. Thus in said example the data-driven decision apparatus 204 can allow for an assessment of the status of the disease and/or its temporal evolution based on the object features. Examples of the data-driven decision apparatus 204 include but are not limited to computer workstation, a handheld computer, a mobile phone, a smart appliance.

The server 206 can be configured to store the training imaging datasets for the at least one trained artificial neural network implemented in the data processing device 202. In some embodiments, the server 206 can also store metadata related to the training data. The server 206 can also store the input image 210 as well as some metadata related to the input image 210. The server 206 can be designed to send the input image 210 to the data processing apparatus 202 via the communication network 208, and/or to receive the output objects and features of the input image 210 from the data processing apparatus 202 via the communication network 208. The server 206 can also be configured to receive and store the score associated with the object features from the data-driven decision apparatus 204 via the communication network 208. Examples of the server 206 include but are not limited to application servers, cloud servers, database servers, file servers, and/or other types of servers.

The communication network 208 can comprise the means through which the data processing apparatus 202, the data-driven decision apparatus 204 and the server can be communicatively coupled. Examples of the communication network 208 include but are not limited to the Internet, a cloud network, a Wi-Fi network, a Personal Area Network (PAN), a Local Area Network (LAN) or a Metropolitan Area Network (MAN). Various devices of the system 200 can be configured to connect with the communication network 208 with wired and/or wireless protocols. Examples of protocols include but are not limited to Transmission Control Protocol/Internet Protocol (TCP/IP), Hypertext Transfer Protocol (HTTP), File Transfer Protocol (FTP), Bluetooth (BT).

The at least one trained artificial neural network can be deployed on the data processing apparatus 202 and can be configured to output extracted features of the objects of interest from the input image fed to the trained artificial neural network. The at least one trained artificial neural network can include a plurality of interconnected processing units, also referred to as neurons, arranged in at least one hidden layer plus an input layer and an output layer. Each neuron can be connected to other neurons, with connections modulated by weights.

Prior to deployment on the data processing apparatus 202, the at least one trained artificial neural network can be obtained through a training process on an artificial neural network architecture initialized with random weights. The training dataset can include pairs of images and their metadata, e.g. pre-annotated images in the case of digital images from brain MRI scans. The metadata can comprise the number and position of objects in the images, as well as a shallow or detailed object classification. In an embodiment, the annotation can be performed manually by radiologists. In a further embodiment, the metadata can comprise the confidence-level of the radiologists in performing the annotation. In another embodiment, the training process is performed on an artificial neural network architecture with a training dataset of unlabelled images. Unlabelled images can be images without any associated metadata. The artificial neural network architecture can learn the output features of said unlabelled images via an unsupervised learning process. In an exemplary embodiment, the training dataset can be stored in the server 206 and/or the training process can be performed by the server 206.

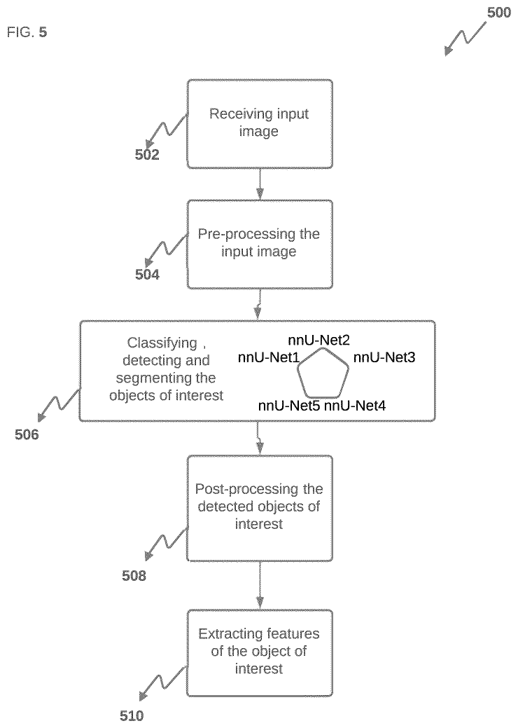

In some embodiments, the trained artificial neural network can be a trained Convolutional Neural Network (CNN). Processing units in the early layers of CNNs learn to activate in response to simple local features, for example patterns at particular orientations or edges, while units in the deeper layers combine the low-level features into more complex patterns. In other embodiments, the trained artificial neural network can be an end-to-end deep learning-powered pipeline. The process of image detection and segmentation in an embodiment designed with an end-to-end deep-learning powered pipeline is described, for example, in FIG. 5.

The set of images and associated scores produced by the data-driven decision apparatus 204 can be deployed on the server 206 to be added to the training dataset for a further training process of the network. Images with scores as their associated metadata provided by the data-driven decision apparatus 204 can be used as an alternative training dataset for a supervised learning process. In some other embodiments, all functionalities of the data-driven decision apparatus 204 are implemented in the data processing apparatus 202.

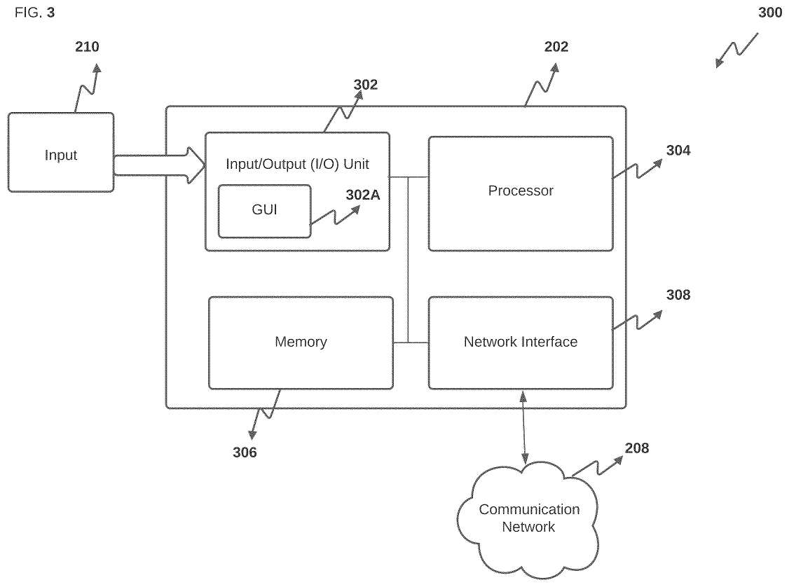

FIG. 3 depicts a block diagram that illustrates an exemplary data processing apparatus for object detection, segmentation and characterization using at least one trained artificial neural network, in accordance with an example of the invention. FIG. 3 is explained in conjunction with elements from FIG. 2. With reference to FIG. 3, it is shown a block diagram 300 of the data processing apparatus 202. The data processing apparatus 202 can include an Input/Output (I/O) unit 302 further comprising a Graphical User Interface (GUI) 302A, a processor 304, a memory 306 and a network interface 308. The processor 304 can be communicatively coupled with the memory 306, the I/O unit 302, the network interface 308. In one or more embodiments, the data processing apparatus 202 can also include provisions to correlate the results of the data processing with one or more scoring systems.

The I/O unit 302 can comprise suitable logic, circuitry and interfaces that can act as interface between a user and the data processing apparatus 202. The I/O unit 302 can be configured to receive an input image 210 containing at least one object of interest 212. The I/O unit 302 can include different operational components of the data processing apparatus 202. The I/O unit 302 can be programmed to provide a GUI 302A for user interface. Examples of the I/O unit 302 can include, but are not limited to, a touch screen, a keyboard, a mouse, a joystick, a microphone, and a display screen, like for example a screen displaying the GUI 302A.

The GUI 302A can comprise suitable logic, circuitry and interfaces that can be configured to provide the communication between a user and the data processing apparatus 202. In some embodiments, the GUI can be displayed on an external screen, communicatively or mechanically coupled to the data processing apparatus 202. The screen displaying the GUI 302A can be a touch screen or a normal screen.

The processor 304 can comprise suitable logic, circuitry and interfaces that can be configured to execute programs stored in the memory 306. The programs can correspond to sets of instructions for image processing operations, including but not limited to object detection and segmentation. In some embodiments, the sets of instructions also include the object characterization operation, including but not limited to feature extraction. The processor 304 can be built on a number of processor technologies known in the art. Examples of the processor 304 can include, but are not limited to, Graphical Processing Units (GPUs), Central Processing Units (CPUs), motherboards, network cards.

The memory 306 can comprise suitable logic, circuitry and interfaces that can be configured to store programs to be executed by the processor 304. Additionally, the memory 306 can be configured to store the input image 210 and/or its associated metadata. In another embodiment, the memory can store a subset of or the entire training dataset, comprising in some embodiments the pair of images and their associated metadata. Examples of the implementation of the memory 306 can include, but are not limited to, Random Access Memory (RAM), Read Only Memory (ROM), Hard Disk Drive (HDD), Solid State Drive (SDD) and/or other memory systems.

The network interface 308 can comprise suitable logic, circuitry and interfaces that can be configured to enable the communication between the data processing apparatus 202, the data-driven decision apparatus 204 and the server 206 via the communication network 208. The network interface 308 can be implemented in a number of known technologies that support wired or wireless communication with the communication network 208. The network interface 308 can include, but is not limited to, a computer port, a network interface controller, a network socket or any other network interface systems.

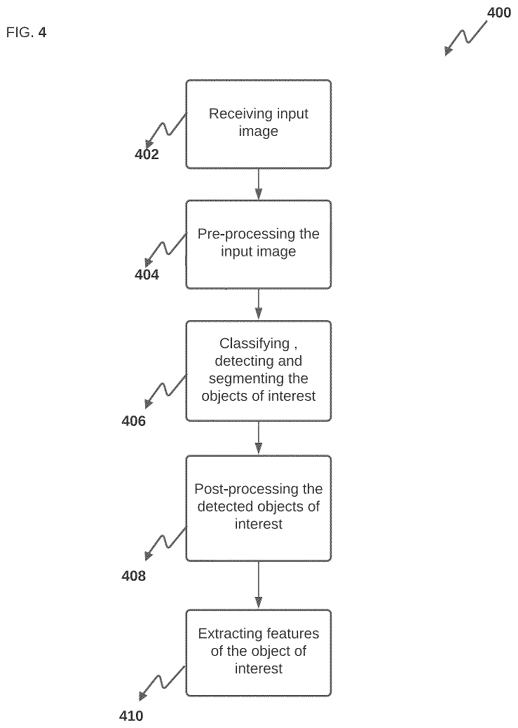

FIG. 4 depicts a flow chart that illustrates an exemplary method for object detection, segmentation and characterization in a digital brain image using at least one trained artificial neural network, in accordance with an example of the invention. With reference to FIG. 4, an exemplary workflow 400 is shown.

The input image 402 can comprise at least one object of interest. Said image can be obtained from a combination of MRI brain scan sequences of pre- or post-surgical Glioblastoma (GBM) patients. MRI sequences can comprise, but be not limited to, native T1-weighted, post-contrast T1-weighted, T2-weighted and T2-Fluid Attenuated Inversion Recovery (FLAIR) MRI sequences. Objects of interest can comprise tumor lesions, including but not limited to contrast-enhancing tumor (ET), regions of edema (ED), and in the case of post-surgical sequences the surgical cavity. In some examples, the MRI sequences can be co-registered.

At 404, a pre-processing of the input image 402 can be executed. The pre-processing can include but not be limited to the extraction of the skull, also known as skull stripping. In some examples, the skull stripping can be performed with an HD-BET algorithm (Isensee F, Schell M, Tursunova I, Brugnara G, Bonekamp D, Neuberger U, Wick A, Schlemmer H P, Heiland S, Wick W, Bendszus M, Maier-Hein K H, Kickingereder P. Automated brain extraction of multi-sequence MRI using artificial neural networks. Hum Brain Mapp. 2019; 1-13, https://doi.orq/10.1002/hbm.24750), with or without any additional training, and run independently for each sequence. In some examples, in parallel with the skull stripping, the sequence with the smallest voxel size can be determined and re-oriented to the Right, Anterior, Superior (RAS) coordinate system. The brain probability maps and the remaining sequences can be re-sampled to the sequence with the smallest voxel size. Further, the brain probability maps returned from HD-BET can be binarized, and the skull stripping be performed in all sequences.

At 406, the trained algorithm for classification, detection and segmentation of the at least one object of interest can be run. In some examples, the trained algorithm can include but not be limited to deep neural networks (DNNs), convolutional neural networks (CNNs), Region-based CNNs (R-CNNs), Faster R-CNNs, Mask R-CNNs. In some other examples, an end-to-end deep learning-powered pipeline is employed, to reduce the complexity arising from training several algorithms.

At 408, a post-processing of the detected at least one object of interest can be performed. For images obtained from post-surgical brain MRI scan sequences, the removal of false positives (FPs) that can arise from hyper-intense regions along the surgical cavity in post-contrast T1-weighted sequences can be necessary. The removal of FPs can be performed by automatically removing all detected ET voxels that do not have ED neighbours.

At 410, features can be extracted from the at least one detected and segmented object of interest. Features of interest of segmented brain lesions can include but not be limited to: bidimensional diametrical measurements, according to the RANO criteria, which can be obtained by maximizing the major and minor diameters of the ET sequentially; bidimensional diametrical measurements, according to the RANO criteria, which can be obtained by maximizing the product of the major and minor diameters of the ET; volumetric measurements of the ET; volumetric measurements of the ED; volumetric measurements of the surgical cavity. In some examples, a fully automatic algorithm is employed for calculating bidimensional diametrical measurements in post-contrast T1-weighted sequences. Such an algorithm can search for, in each detected ET region in the input 3D volume, the longest segment (major diameter) over all slices, and the corresponding longest perpendicular diameter, with a tolerance of for example 5 degrees inclusive, and further calculate the product of the perpendicular diameters. Some algorithms can reject the segments if not fully inscribed in the ET, or if not at least 10 millimeters long. If there are more measurable ET regions, the sum of up to five largest products can be returned. Alternative examples can optimize the product of the diameters instead of the maximum diameters, thus being less sensitive to small alterations in the contour of the lesions. The step of feature extraction 410 can comprise a quantitative and statistical analysis of the manual and automated segmentation. Examples of evaluated quality parameters can be the DICE coefficient, the Jaccard's index (also known as the Intersection over Union), sensitivity and specificity.

FIG. 5 depicts a flow chart that illustrates an exemplary method for object detection, segmentation and characterization in a digital brain image using a single ensemble of five nnU-Nets, in accordance with an example of the invention. With reference to FIG. 5, an exemplary workflow 500 is shown.

The input image 502 can comprise at least one object of interest. Said image can be obtained from a combination of MRI brain scan sequences of pre- or post-surgical Glioblastoma (GBM) patients. MRI sequences can comprise, but be not limited to, native T1-weighted, post-contrast T1-weighted, T2-weighted and T2-Fluid Attenuated Inversion Recovery (FLAIR) MRI sequences. Objects of interest can comprise tumor lesions, including but not limited to contrast-enhancing tumor (ET), regions of edema (ED), and in the case of post-surgical sequences the surgical cavity. In some examples, the MRI sequences can be co-registered.

At 504, a pre-processing of the input image 502 can be executed. The pre-processing can include but not be limited to the extraction of the skull, also known as skull stripping. In some examples, the skull stripping can be performed with an HD-BET algorithm, with or without any additional training, and run independently for each sequence. In some examples, in parallel with the skull stripping, the sequence with the smallest voxel size can be determined and re-oriented to the Right, Anterior, Superior (RAS) coordinate system. The brain probability maps and the remaining sequences can be re-sampled to the sequence with the smallest voxel size. Further, the brain probability maps returned from HD-BET can be binarized, and the skull stripping be performed in all sequences.

At 506, the trained algorithm for classification, detection and segmentation of the at least one object of interest can be run. In some examples, an end-to-end deep learning-powered pipeline is employed, to reduce the complexity arising from training several algorithms. In further examples, the end-to-end deep learning-powered pipeline comprises a single ensemble of five nnU-Nets trained over different training sets to process images from both pre- and post-operative brain MRI scans. In further examples, the nnU-Nets can comprise confidence-aware nnU-Nets, which are nnU-Nets trained on datasets comprising confidence estimates.

At 508, a post-processing of the detected at least one object of interest can be performed. For images obtained from post-surgical brain MRI scan sequences, the removal of false positives (FPs) that can arise from hyper-intense regions along the surgical cavity in post-contrast T1-weighted sequences can be necessary. The removal of FPs can be performed by automatically removing all detected ET voxels that do not have ED neighbours.

At 510, features can be extracted from the at least one detected and segmented object of interest. Features of interest of segmented brain lesions can include but not be limited to: bidimensional diametrical measurements, according to the RANO criteria, which can be obtained by maximizing the major and minor diameters of the ET sequentially; bidimensional diametrical measurements, according to the RANO criteria, which can be obtained by maximizing the product of the major and minor diameters of the ET; volumetric measurements of the ET; volumetric measurements of the ED; volumetric measurements of the surgical cavity. In some examples, a fully automatic algorithm is employed for calculating bidimensional diametrical measurements in post-contrast T1-weighted sequences. Such an algorithm can search for, in each detected ET region in the input 3D volume, the longest segment (major diameter) over all slices, and the corresponding longest perpendicular diameter, with a tolerance of for example 5 degrees inclusive, and further calculate the product of the perpendicular diameters. Some algorithms can reject the segments if not fully inscribed in the ET, or if not at least 10 mm long. If there are more measurable ET regions, the sum of up to five largest products can be returned. Alternative examples can optimize the product of the diameters instead of the maximum diameters, thus being less sensitive to small alterations in the contour of the lesions. The step of feature extraction 510 can comprise a quantitative and statistical analysis of the manual and automated segmentation. Examples of evaluated quality parameters can be the DICE coefficient, the Jaccard's index (also known as the Intersection over Union), sensitivity and specificity.

### Example

In an example, a single ensemble of five confidence-aware nnU-Nets trained over different training sets is used to process both pre- and post-operative MRIs, and to automatically detect ET, ED and surgical cavities. It receives as inputs pre-processed native T1, post-contrast T1, T2-weighted and FLAIR sequences and performs z-score normalization, hence each sequence is normalized independently through extracting its mean intensity value and dividing by the standard deviation. The base deep models are ensembled by averaging softmax probabilities. In the example, a fully automatic algorithm for calculating bidimensional measurements in post-contrast T1 sequences is employed. For each detected ET region in the input 3D volume, the algorithm searches for the longest segment (major diameter) over all slices, and then for the corresponding longest perpendicular diameter, with the tolerance of 5 degrees inclusive. Such segments are valid if they (i) are fully inscribed in ET, and (ii) are both at least 10 mm long (otherwise the lesion is not measurable). Finally, the product of the perpendicular diameters is calculated. If there are more measurable ET regions, the sum of up to five largest products is returned. In another example, an alternative consists in optimizing the product of the diameters instead of the maximum diameter, an approach less sensitive to small alterations in the contour of the lesions.

To evaluate the segmentation, the DICE coefficient, the Jaccard's index (also known as the Intersection over Union, IoU), sensitivity and specificity are computed. For those parameters, the larger value obtained the better, with 1.0 denoting a perfect score. In addition, the 95^{th} percentile of Hausdorff distance (H95; the smaller, the better) which quantifies the contours similarity is also calculated. Since the shape of the ET contours may easily affect the RANO calculation, e.g. jagged contours could result in over-pessimistic bidimensional measurements, investigating both overlap measurements (e.g. DICE/IoU) together with H95 is pivotal to evaluate the performance of the algorithm, which should simultaneously obtain maximum overlap metrics and maintain minimum distance between the automatic and manual contours. The inter-rater and algorithm-rater agreement for bidimensional and volume measurements is evaluated using the Intraclass Correlation Coefficient (ICC) calculated on a single measurement, absolute-agreement, two-way random-effects model.

The performance of the automatic segmentation algorithm is evaluated for a pre-operative dataset of 125 patients. For computing the performance matrix in the post-operative setting, scans from patients with existing ground-truth regions from Phase 3 are used (32 for ET regions, 39 for ED regions). For pre-operative patients, mean DICE for ET was 0.744 with median DICE of 0.871 (25% percentile (25p)-75% percentile (75p): 0.781-0.915). The corresponding mean H95 was 39.624 mm with median H95 of 2.000 mm (25p-75p: 1.000-3.399 mm). The cavity was erroneously detected in 8/125 patients (6.4%). For post-operative patients, the median DICE for ET was 0.735 (25p-75p: 0.588-0.801). The mean DICE was 0.692 (95% CI: 0.628-0.757), 0.677 (0.631-0.724) and 0.691 (0.604-0.778) respectively for ET, ED and surgical cavity. Respective values for mean H95 were 9.221 mm (6.437-12.000 mm), 9.455 mm (7.176-11.730 mm) and 7.956 mm (5.9380-9.975 mm). The mean DICE for ET was significantly larger for the data segmented with the highest confidence by the readers, 0.749 (95% CI: 0.698-0.800) for the highest confidence level compared to 0.599 (95% CI: 0.452-0.746) for lower confidence levels. The automated volumetric measurement (in mm3) for ET and the surgical cavity were in almost perfect agreement with the ground-truth segmentations (ICC: 0.959, p<0.001; ICC: 0.960, p<0.001), whereas for ED the agreement was ICC: 0.703, p<0.703).

In the following, further particular embodiments of the present invention are listed.
1. In an embodiment, a method for training an artificial neural network including network parameters is disclosed, the method comprising the steps of:
   a) receiving at least one image (102) from Magnetic Resonance Imaging brain scan sequences of post-surgical Glioblastoma patients, wherein the at least one image comprises at least one object of interest;
   b) receiving a ground-truth pixel-based annotation (104) of the received at least one image, wherein the pixel-based annotation comprises a ground-truth segmentation mask for the at least one object of interest;
   c) obtaining a predicted segmentation mask (108) by feeding the at least one received image (102) to a prediction function (106), wherein the prediction function is defined by randomly initialized model parameters (106A);
   d) calculating the loss (112) using a training function (110), when the predicted segmentation mask (106) and the ground-truth segmentation mask of the annotation (104) are given as input to the training function;
   e) optimizing the model parameters by minimizing the loss (114) with respect to the model parameters;
   f) replacing the model parameters with the optimized model parameters (114A).
2. In an embodiment, a method for training an artificial neural network including network parameters is disclosed, the method comprising the steps of:
   a) receiving at least one image (102) from Magnetic Resonance Imaging brain scan sequences of post-surgical Glioblastoma patients, wherein the at least one image comprises at least one object of interest, wherein the at least one object of interest comprises the contrast-enhancing tumor, the regions of edema, and the surgical cavity;
   b) receiving a ground-truth pixel-based annotation (104) of the received at least one image, wherein the pixel-based annotation comprises a ground-truth segmentation mask for the at least one object of interest;
   c) obtaining a predicted segmentation mask (108) by feeding the at least one received image (102) to a prediction function (106), wherein the prediction function is defined by randomly initialized model parameters (106A);
   d) calculating the loss (112) using a training function (110), when the predicted segmentation mask (106) and the ground-truth segmentation mask of the annotation (104) are given as input to the training function;
   e) optimizing the model parameters by minimizing the loss (114) with respect to the model parameters;
   f) replacing the model parameters with the optimized model parameters (114A).
3. In an embodiment, a method for training an artificial neural network including network parameters is disclosed, the method comprising the steps of:
   a) receiving at least one image (102) from Magnetic Resonance Imaging brain scan sequences of post-surgical Glioblastoma patients, wherein the at least one image comprises at least one object of interest;
   b) receiving a ground-truth pixel-based annotation (104) of the received at least one image, wherein the pixel-based annotation comprises a ground-truth segmentation mask for the at least one object of interest;
   c) obtaining a predicted segmentation mask (108) by feeding the at least one received image (102) to a prediction function (106), wherein the prediction function is defined by randomly initialized model parameters (106A), wherein the prediction function is a single ensemble of multiple base models;
   d) calculating the loss (112) using a training function (110), when the predicted segmentation mask (106) and the ground-truth segmentation mask of the annotation (104) are given as input to the training function;
   e) optimizing the model parameters by minimizing the loss (114) with respect to the model parameters;
   f) replacing the model parameters with the optimized model parameters (114A);
   and wherein the method is performed for each base model.
4. In an embodiment, a method for training an artificial neural network including network parameters is disclosed, the method comprising the steps of:
   a) receiving at least one image (102) from Magnetic Resonance Imaging brain scan sequences of post-surgical Glioblastoma patients, wherein the at least one image comprises at least one object of interest, wherein the at least one object of interest comprises the contrast-enhancing tumor, the regions of edema, and the surgical cavity; b) receiving a ground-truth pixel-based annotation (104) of the received at least one image, wherein the pixel-based annotation comprises a ground-truth segmentation mask for the at least one object of interest;
   c) obtaining a predicted segmentation mask (108) by feeding the at least one received image (102) to a prediction function (106), wherein the prediction function is defined by randomly initialized model parameters (106A), wherein the prediction function is a single ensemble of multiple base models;
   d) calculating the loss (112) using a training function (110), when the predicted segmentation mask (106) and the ground-truth segmentation mask of the annotation (104) are given as input to the training function;
   e) optimizing the model parameters by minimizing the loss (114) with respect to the model parameters;
   f) replacing the model parameters with the optimized model parameters (114A);
   and wherein the method is performed for each base model.
5. In another embodiment, the method according to the preceding embodiment is disclosed, wherein the steps are performed sequentially.
6. In another embodiment, the method according to any of the preceding embodiments is disclosed, wherein steps c) to f) are repeated for more than one epoch.
7. In another embodiment, the method according any of the preceding embodiments is disclosed, wherein the one or more images are obtained from any combination of native T1-weighted, post-contrast T1-weighted, T2-weighted and T2-Fluid Attenuated Inversion Recovery MRI sequences, including single sequences, groups of two sequences, groups of three sequences and/or all four sequences.
8. In another embodiment, the method of any of the preceding embodiments is disclosed, wherein the one or more images each comprise multiple objects of interest, including the contrast-enhancing tumor, the regions of edema.
9. In another embodiment, the method of any of the preceding embodiments is disclosed, one prediction function per object of interest and one training function per object of interest are implemented.
10. In another embodiment, the method of any of the preceding embodiments is disclosed, wherein the training function of step d) is averaged over all objects of interest.
11. In another embodiment, the method of any of the preceding embodiments is disclosed, wherein the one or more images each comprise multiple objects of interest, including the contrast-enhancing tumor, the regions of edema, and the surgical cavity, and wherein one prediction function per object of interest and one training function per object of interest are implemented, and wherein the training function of step d) is averaged over all objects of interest.
12. In another embodiment, the method of any of the preceding embodiments is disclosed, wherein the prediction function is a single ensemble of multiple base models.
13. In another embodiment, the method of any of the preceding embodiments is disclosed, wherein the prediction function is a single ensemble of multiple base models, and wherein the training is performed for each base model.
14. In another embodiment, the method of any of the preceding embodiments is disclosed, wherein the prediction function is a single ensemble of five confidence-aware nnU-Nets, and wherein the training is performed for each base model.
15. In another embodiment, the method of any of the preceding embodiments is disclosed, wherein the training is performed on four separate sets of received images, wherein the sets are defined based on ranges of the volume distributions of the contrast-enhancing tumor and the regions of edema.
16. In another embodiment, the method of any of the preceding embodiments is disclosed, wherein the training is performed for at least 500 epochs, in particular for 1000 epochs.
17. In another embodiment, the method of any of the preceding embodiments is disclosed, wherein the training is performed for maximum 1000 epochs and wherein an early stopping condition is applied.
18. In another embodiment, the method of any of the preceding embodiments is disclosed, wherein 250 batches are processed within one epoch, and wherein each batch includes two patches of size 208×238×196.
19. In another embodiment, the method of any of the preceding embodiments is disclosed, wherein within one epoch at least 100 batches are processed, in particular 250 batches.
20. In another embodiment, the method of any of the preceding embodiments is disclosed, wherein the training is performed applying on the images a random patch scaling within a range (0.7, 1.4), and/or a random rotation, and/or a random gamma correction within a range (0.7,1.5) and/or a random mirroring.
21. In another embodiment, the method of any of the preceding embodiments is disclosed, wherein the step e) of optimizing the model parameters by minimizing the loss (114) with respect to the model parameters is performed using a stochastic gradient descent.
22. In another embodiment, the method according to the preceding embodiment is disclosed, wherein the stochastic gradient descent is performed with Nesterov momentum.
23. In another embodiment, the method according to the preceding embodiment is disclosed, wherein the stochastic gradient descent is performed with Nesterov momentum within (0.9,0.99).
24. In an embodiment, the use of an artificial neural network model is disclosed, to detect, segment and characterize objects of interest in images obtained from MRI brain scan sequences of post-surgical Glioblastoma patients.
25. In another embodiment, the use of an artificial neural network model according to the preceding embodiment is disclosed, trained according to any of the preceding embodiments, and wherein the objects of interest comprise the contrast-enhancing tumor, the regions of edema, and the surgical cavity.
26. In another embodiment, the use of an artificial neural network model according to the preceding embodiment is disclosed, wherein the features of the objects of interest extracted in the characterization step comprise volumetric and bidimensional diametrical measurements.

While the present invention is described with reference to certain embodiments, it will be understood by those skilled in the art that various changes can be made and equivalents can be substituted without departure from the scope of the present invention. In addition, many modifications can be made to adapt a particular situation or material to the teachings of the present invention without departure from its scope. Therefore, it is intended that the present invention not be limited to the particular embodiments disclosed, but that the present invention will include all embodiments that fall within the scope of the appended claims.

What is claimed is:

1. A method for training an artificial neural network, the method comprising the steps of:
a) receiving at least one image (102) from Magnetic Resonance Imaging brain scan sequences of post-surgical Glioblastoma patients, wherein the at least one image comprises at least one object of interest;
b) receiving a ground-truth pixel-based annotation (104) of the received at least one image, wherein the annotation comprises a ground-truth segmentation mask for the at least one object of interest;
c) obtaining a predicted segmentation mask (108) by feeding the at least one received image (102) to a prediction function (106), wherein the prediction function is defined by randomly initialized model parameters (106A);
d) calculating the loss (112) using a training function (110), when the predicted segmentation mask (106) and the ground-truth segmentation mask of the annotation (104) are given as input to the training function;
e) optimizing the model parameters by minimizing the loss (114) with respect to the model parameters;
f) replacing the model parameters with the optimized model parameters (114A).

2. The method of claim 1, wherein the one or more images are obtained from any combination of native T1-weighted, post-contrast T1-weighted, T2-weighted and T2-Fluid Attenuated Inversion Recovery MRI sequences, including single sequences, groups of two sequences, groups of three sequences and/or all four sequences.

3. The method of claim 1, wherein the one or more images each comprise multiple objects of interest, including the contrast-enhancing tumor, the regions of edema, and the surgical cavity, and wherein one prediction function per object of interest and one training function per object of interest are implemented, and wherein the training function of step d) is averaged over all objects of interest.

4. The method of claim 1, wherein the prediction function is a single ensemble of multiple base models, and wherein the method is performed for each base model.

5. The method of claim 4, wherein the prediction function is a single ensemble of five confidence-aware nnU-Nets, and wherein the training is performed for each nnU-Net.

6. The method of claim 1, wherein the training is performed on four separate sets of received images, wherein the sets are defined based on ranges of the volume distributions of the contrast-enhancing tumor and the regions of edema.

7. The method of claim 1, wherein the training is performed for at least 500 epochs, in particular for 1000 epochs.

8. The method of claim 1, wherein within one epoch at least 100 batches are processed, in particular 250 batches.

9. The method of claim 8, wherein the training is performed applying on the images a random patch scaling within a range (0.7, 1.4), and/or a random rotation, and/or a random gamma correction within a range (0.7,1.5) and/or a random mirroring.

10. The method of claim 1, wherein the step e) of optimizing the model parameters by minimizing the loss (114) with respect to the model parameters is performed using a stochastic gradient descent.

11. The method of claim 10, wherein the stochastic gradient descent is performed with Nesterov momentum within (0.9,0.99).

12. The use of an artificial neural network model trained according to claim 1 to detect, segment and characterize objects of interest in images obtained from MRI brain scan sequences of post-surgical Glioblastoma patients, and wherein the objects of interest comprise the contrast-enhancing tumor, the regions of edema, and the surgical cavity.

13. (canceled)

14. The use of an artificial neural network model according claim 12, wherein the features of the objects of interest extracted comprise volumetric and bidimensional diametrical measurements.

15. (canceled)
